(19) United States
(12) Patent Application Publication
(10) Pub. No.: US 2026/0042652 A1
(43) Pub. Date: Feb. 12, 2026

(54) SETTING OF A CLEANING OPERATION FOR A CONTAINER FILLING APPARATUS

(71) Applicant: KRONES AG, Neutraubling (DE)

(72) Inventors: Josef DOBLINGER, Reichenbach (DE); Florian HERRMANN, Sarching (DE); Johanna JUSTL, Sinzing (DE); Anton HUBER, Mainburg (DE); Tobias BOCK, Hemau (DE); Stefan STAUDINGER, Donaustauf (DE); Timm HORSTMANN, Regensburg (DE)

(21) Appl. No.: 19/293,594

(22) Filed: Aug. 7, 2025

(30) Foreign Application Priority Data
Aug. 7, 2024 (DE) 10 2024 122 463.0

(51) Int. Cl. B67C 3/00; B08B 9/032

(52) U.S. Cl. CPC B67C 3/001; B08B 9/0322; B08B 9/0325; B08B 2209/032

(57) ABSTRACT

The invention relates, inter alia, to a method for setting a cleaning operation of an apparatus for filling containers with a filling material. The apparatus has several filling stations, each having a filling material path, a filling material path valve arranged in the corresponding filling material path, and a flow meter arranged to measure a flow rate through the corresponding filling material path. A cleaning medium is passed through at least some of the filling material paths by releasing at least some of the filling material paths by opening the corresponding filling material path valves. Cleaning medium flow rates through the released filling material paths are measured by the corresponding flow meters. At least one valve actuation parameter of the cleaning operation of the apparatus is set depending on the measured cleaning medium flow rates.

### CROSS-REFERENCE TO RELATED APPLICATIONS

This application claims the benefit under 35 U.S.C. § 119 (a) of German Patent Application No. DE 10 2024 122 463.0, filed Aug. 7, 2025, entitled IMPROVED SETTING OF A CLEANING OPERATION FOR A CONTAINER FILILNG APPARATUS, and whose entire disclosure is incorporated by reference herein.

### TECHNICAL FIELD

The invention relates to a method for setting a cleaning operation of an apparatus for filling containers with a filling material. The invention further relates to a method for cleaning an apparatus for filling containers with a filling material. The invention further relates to an apparatus for filling containers with a filling material.

### TECHNICAL BACKGROUND

Various methods are known for cleaning and sterilizing filling apparatuses for filling containers with a filling product, such as beverages. In this way, the so-called CIP (“cleaning-in-place”) and SIP (“sterilization-in-place”) methods have for example established themselves, in which a disassembly of the components and faces touched by the filling product or the intermediate products and auxiliaries can be substantially dispensed with. For example, the filling elements do not have to be removed for cleaning or sterilization, but are flushed or steamed with a cleaning medium in their installed state. A “CIP” or “SIP” cleaning can also be described as an internal cleaning of the processing machine, i.e., product paths, gas paths, pipes, etc. The present disclosure in particular relates to this internal cleaning. In comparison, for example, the abbreviation “COP” refers to exterior cleaning (all exterior surfaces).

The SIP method is herein subsumed under the CIP method for the sake of simplicity of language, i.e., the CIP method comprises a cleaning and/or sterilization.

WO 2019/043240 A1 discloses an apparatus for filling a container with a filling product. In order to allow venting of the container filled with the carbonated filling product at the filling valve before removing the container from the filling valve, a relief line is preferably provided which is led outwards via a rotary distributor. This relief line and the rotary distributor can also be used to carry out CIP cleaning of the filling-product-carrying regions of the apparatus.

DE 10 2019 132 749 A1 discloses an apparatus for filling a container with a filling product, preferably in a beverage filling plant, as well as methods for cleaning and sterilizing such an apparatus. The apparatus has a main component supply for supplying a main component, preferably water, of the filling product, at least one filling element in fluid communication with the main component supply for filling the container to be filled with the filling product, and a CIP device for cleaning and sterilizing components of the apparatus that come into contact with the filling product by a CIP medium.

Traditionally, the cleaning operation is set manually on-site, which is difficult and error-prone. In this respect, the cleaning operation may not be able to ensure adequate cleaning, in particular if, in addition to the filling material paths, gas paths, such as the charging gas paths, also have to be cleaned with the cleaning medium. During the cleaning operation, unwanted pressure surges may also occur in the system, which may, for example, lead to damage to the bellows.

The invention is based on the object of creating an improved technique for setting a cleaning operation of an apparatus for filling containers, with which preferably at least some of the disadvantages mentioned above can be overcome.

### SUMMARY OF THE INVENTION

The object is achieved by the features of the independent claims. Advantageous developments are specified in the dependent claims and the description.

One aspect relates to a method for (e.g., automatically) setting a cleaning operation of an apparatus, preferably a rotary apparatus, for filling containers with a (e.g., liquid or pasty) filling material (e.g., beverage or food). The apparatus has several filling stations, each having a filling material path, a filling material path valve arranged in the corresponding filling material path and a flow meter arranged to measure a flow rate through the corresponding filling material path. The method comprises the following:
passing a cleaning medium (e.g., from a cleaning medium source of the apparatus) (e.g., only) through at least some of the filling material paths by releasing at least some of the filling material paths by opening the corresponding filling material path valves;
(e.g., repeatedly) measuring cleaning medium flow rates through the released filling material paths using the corresponding flow meters; and
(e.g., automatically) setting at least one (e.g., apparatus and/or filling station) valve actuation parameter of the cleaning operation of the apparatus depending on the measured cleaning medium flow rates (e.g., by a processing device of the apparatus).

Advantageously, the method allows for improved setting of the cleaning operation by using device technology for the filling operation, namely the flow meters. The flow meters can not only be used during filling operations to ensure a constant filling volume in the containers, but also advantageously to measure cleaning medium flow rates. The measurements can be evaluated to find the most optimal valve actuation parameters for the cleaning operation and to set them accordingly. In particular, it can be determined how many paths can be flowed through with cleaning medium simultaneously so that sufficient cleaning can still be achieved (e.g., flow through the corresponding path at a sufficient rate for a given pipe diameter). The resulting switching characteristic between the corresponding released paths can then preferably ensure that the total cleaning medium volume flow can be kept substantially constant during the cleaning operation, which is particularly preferred since it can, for example, reduce unwanted pressure surges in the system. In addition, error situations can be quickly identified and reported. The use of existing equipment (=flow meter) advantageously allows a cost-effective and simple implementation of the method. In addition to cleaning processes, the principle can also be applied, for example, to ejection or emptying processes.

In one exemplary embodiment, the at least one valve actuation parameter comprises a target number of simultaneously opened filling material path valves during the cleaning operation. This can advantageously ensure that during the cleaning operation not too many filling material path valves are opened simultaneously and thus not too many filling material paths are released for the passage of the cleaning medium at the same time, so that a sufficient supply of cleaning medium to each filling material path can be ensured. On the other hand, it can be advantageously ensured that not too few filling material path valves are opened simultaneously and thus too few filling material paths are released for the passage of the cleaning medium at the same time, so that the cleaning operation does not take too long. By setting the target number, it is also relatively easy to ensure that the total cleaning medium flow rate is kept constant, so that unwanted pressure surges, for example when switching over, can be prevented or at least reduced.

In a further exemplary embodiment, the setting of the at least one valve actuation parameter is further dependent on a predefined cleaning medium supply from a cleaning medium source of the apparatus, wherein preferably the predefined cleaning medium supply is a nominal supply (available supply) of the cleaning medium from the cleaning medium source. Advantageously, the at least one valve actuation parameter, such as the specified target number, can be adapted to the nominal supply, so that the total cleaning medium flow rate can be kept constant in accordance with the nominal supply, whereby a particularly effective cleaning operation can be achieved.

In one embodiment, at least one of the following conditions is met:
the target number of simultaneously open filling material path valves during the cleaning operation is set as the number of open filling material path valves at which a sum of the measured cleaning medium flow rates substantially corresponds to the predefined cleaning medium supply;
the target number of simultaneously open filling material path valves during the cleaning operation is set such that, if a sum of the measured cleaning medium flow rates is less than the predefined cleaning medium supply, a number of released filling material paths is increased by (e.g., successively) opening at least one further one of the filling material path valves until the number of open filling material path valves is reached at which a sum of the measured cleaning medium flow rates determined for the increased number of released filling material paths substantially corresponds to the predefined cleaning medium supply; and
the target number of simultaneously open filling material path valves during the cleaning operation is set such that, if a sum of the measured cleaning medium flow rates is greater than the predefined cleaning medium supply, a number of released filling material paths is reduced by (e.g., successively) closing at least one of the open filling material path valves until the number of open filling material path valves is reached at which a sum of the measured cleaning medium flow rates determined for the reduced number of released filling material paths substantially corresponds to the predefined cleaning medium supply.

In this way, an optimal target number of simultaneously open filling material path valves for the cleaning operation can advantageously be determined iteratively.

In a further embodiment, the method further comprises outputting a (e.g., visual and/or acoustic) fault message using a user interface of the apparatus if a sum of the measured cleaning medium flow rates is outside (e.g., greater or smaller) a predefined tolerance range, preferably starting from the predefined cleaning medium supply. This also makes it advantageous to detect errors in the cleaning agent supply and distribution, so that they can be subsequently checked and corrected, for example manually.

In one embodiment variant, the several filling stations further each have a gas path (gas supply path), preferably a charging gas path, and a gas path valve, preferably a charging gas path valve, arranged in the corresponding gas path. Preferably, the at least one valve actuation parameter comprises a target number of simultaneously opened gas path valves during the cleaning operation. Particularly preferably, the target number of simultaneously open gas path valves is set as the number of open gas path valves at which a predefined minimum flow and/or a predefined minimum flow rate through the released gas paths is achieved, and/or the target number of simultaneously open gas path valves during the cleaning operation and a target number of simultaneously open filling material path valves during the cleaning operation are adjusted in a coordinated manner.

This can advantageously ensure that during the cleaning operation not too many gas path valves and, if applicable, filling material path valves are opened simultaneously and thus not too many gas or filling material paths are released for the passage of the cleaning medium at the same time, so that a sufficient supply of cleaning medium to each path can be ensured. On the other hand, it can be advantageously ensured that not too few paths are open simultaneously and thus not too few paths are released for the passage of the cleaning medium at the same time, so that the cleaning operation does not take too long. By setting the target number, it is also relatively easy to ensure that the total cleaning medium flow rate is kept constant, so that unwanted pressure surges, for example when switching over, can be prevented or at least reduced. This is particularly advantageous without the need for separate flow measurements and corresponding measuring equipment in the gas paths. Instead, for example, the cleaning medium flow rates through the gas paths can be inferred based on the cleaning medium flows through the released filling material paths, e.g., if a total flow is additionally known or measured, as described, for example, in more detail in the following preferred examples.

In one exemplary embodiment, the method further comprises the following:
passing the cleaning medium through at least some, preferably all, of the gas paths by releasing at least some of the gas paths by opening the corresponding gas path valves, preferably in a simultaneously or temporally overlapping manner with the passing of the cleaning medium through at least some of the filling material paths.

In one exemplary embodiment, the method further comprises the following:
measuring a cleaning medium supply from a cleaning medium source of the apparatus and/or a cleaning medium discharge from the several filling stations (e.g., measured in a cleaning medium return of the apparatus), wherein preferably the setting of the at least one valve actuation parameter is further dependent on the measured cleaning medium supply and/or the measured cleaning medium discharge.

In one embodiment, the method further comprises:
determining a cleaning medium flow rate through the released gas paths depending on the measured cleaning medium flow rates through the released filling material paths and on the measured cleaning medium supply and/or the measured cleaning medium discharge, wherein preferably the setting of the at least one valve actuation parameter is further dependent on the determined cleaning medium flow rate through the released gas paths.

In a further embodiment, at least one of the following conditions is met:
the filling material path valves are closed-loop or open-loop control valves and/or are configured to adjust (e.g., continuously or stepwise) a flow cross section between an open position and a closed position; and
the filling material path valves are operated (e.g., by a processing device of the apparatus) in such a way that they each close with a pressure-shock-damping closing characteristic and/or do not close abruptly.

This advantageously allows for smooth switching between paths released for the cleaning medium (filling material paths and optionally gas paths), whereby further unwanted pressure surges can be reduced.

In one embodiment variant, the cleaning medium passed through (e.g., through the released filling material paths and/or the released gas paths) is dispensed from the filling station into an environment of the filling station. Alternatively, the cleaning medium passed through (e.g., through the released filling material paths and/or the released gas paths) can be guided from a cleaning cap (e.g., CIP or SIP) of the corresponding filling station positioned at a filling material outlet of the corresponding filling station to a cleaning medium return, preferably via a relief path of the corresponding filling station. The technology described herein can therefore be used advantageously, for example, in rinsing processes, CIP cleaning processes and SIP cleaning processes.

In a further embodiment variant, the several filling stations each have a filling valve arranged in the corresponding filling material path downstream of the corresponding filling material path valve for dispensing the filling material into a container. During the passage of the cleaning medium (e.g., through the released filling material paths and/or through the released gas paths), the filling valve of the corresponding filling station is open or the filling valves of all filling stations are open.

A further aspect of the present disclosure relates to a method for cleaning an apparatus, preferably a rotary apparatus, for filling containers with a (e.g., liquid or pasty) filling material (e.g., beverage or food), wherein the apparatus has several filling stations, each having a filling material path, a filling material path valve arranged in the corresponding filling material path and a flow meter arranged to measure a flow rate through the corresponding filling material path. The method comprises the following:
(e.g., automatically) setting a cleaning operation of the apparatus by a method as disclosed herein; and
(e.g., automatically) performing the cleaning operation to clean the apparatus.

Preferably, at least one of the following conditions is met:
setting is carried out before carrying out the cleaning operation, preferably during initial commissioning of the apparatus;
setting is carried out at the beginning of the cleaning operation, preferably for the initial setting of the cleaning operation being carried out; and
setting is carried out, preferably several times, during the cleaning operation, preferably for dynamically adjusting the cleaning operation being carried out.

In one exemplary embodiment, the cleaning operation is carried out in such a way that the filling material path valves and/or gas path valves of the apparatus are opened and closed, preferably in a rolling manner, in accordance with the at least one valve actuation parameter set, preferably to keep a constant total cleaning medium flow rate through the several filling stations. Alternatively or additionally, the filling material path valves are operated (e.g., by a processing device of the apparatus) in such a way that they each close with a pressure-shock-damping closing characteristic and/or do not close abruptly.

A further aspect relates to an apparatus, preferably a rotary apparatus, for filling containers with a (e.g., liquid or pasty) filling material (e.g., beverage or food), wherein the apparatus is configured to carry out a method as disclosed herein.

For example, the apparatus may have several filling stations, each having a filling material path, a filling material path valve arranged in the corresponding filling material path and a flow meter arranged to measure a flow rate through the corresponding filling material path. Optionally, the several filling stations further each have a gas path (gas supply path), preferably a charging gas path, and a gas path valve, preferably a charging gas path valve, arranged in the corresponding gas path. The apparatus may further comprise a processing device which, for example, together with the filling stations, is configured to carry out a method as disclosed herein.

A further aspect relates to a container processing plant (e.g., for controlling the temperature of, producing, cleaning, coating, testing, filling, closing, pasteurizing, labeling, printing, marking, laser marking, and/or packaging containers for liquid or pasty media, preferably beverages, liquid foods, or products from the pharmaceutical or healthcare industry). The container processing plant can comprise the apparatus as disclosed herein.

For example, the containers can be configured as bottles, cans, canisters, cartons, vials, tubes, etc.

Preferably, the term “processing device” can refer to an electronic system (for example, configured as a driver circuit or with microprocessor(s) and data memory) which, depending on the configuration, can perform open-loop and/or closed-loop control tasks and/or processing tasks. Although the term “control” is used herein, this can also comprise or be understood as “closed-loop control” or “control with feedback” and/or “processing” as appropriate.

It is understood that the term cleaning medium comprises any medium suitable for cleaning, particularly preferably CIP and/or SIP cleaning medium. As a cleaning medium, for example, steep water for rinsing or a lye solution can be used.

The preferred embodiments and features of the invention described above can be combined with one another as desired.

### BRIEF DESCRIPTION OF THE FIGURES

Further details and advantages of the invention are described below with reference to the accompanying drawings, in which:

FIG. 1 shows a schematic representation of a section of an apparatus for filling containers in accordance with an exemplary embodiment; and

FIG. 2 shows a schematic representation of a filling station of the exemplary apparatus.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

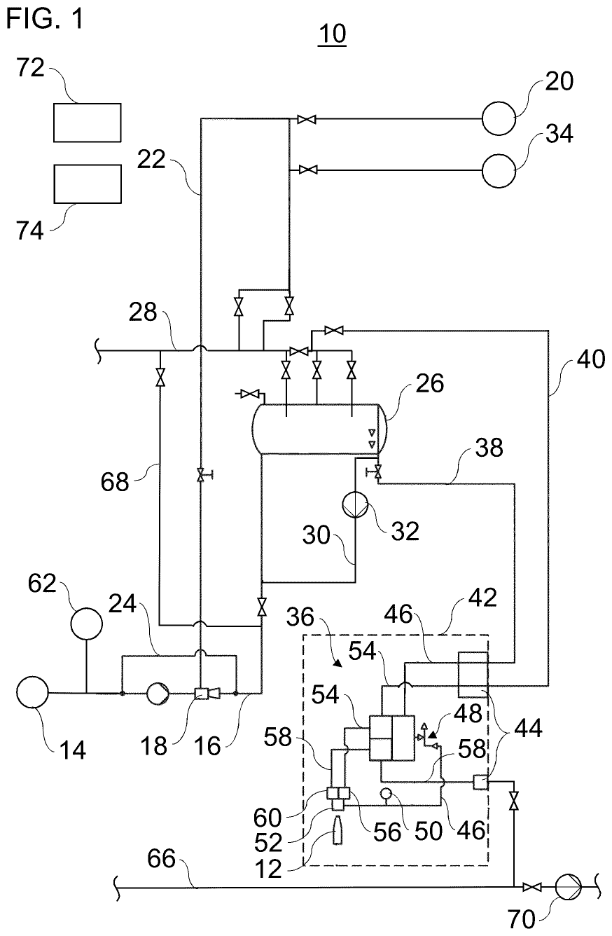

FIG. 1 shows a section of an apparatus 10 for filling containers 12 with a filling material. The apparatus 10 may preferably be included in a container processing plant. The apparatus 10 is preferably a beverage filling apparatus. Preferably, the filling material can be a beverage.

The apparatus 10 has several filling stations 36, of which only one is shown in FIG. 1 for the sake of clarity. The apparatus 10 may further comprise, for example, a filling material source 14, a carbon dioxide source 20, a buffer tank 26, a sterile air or nitrogen source 34 and/or a cleaning medium source 62.

The filling material source 14, which is shown only schematically in FIG. 1, can provide a filling material for filling the containers 12. The filling material provided can be, for example, (product) water or a (product) water-syrup mixture. The water can, for example, be pre-cleaned, degassed and/or treated. At least one syrup may be added to the water.

The filling material can be supplied from the filling material source 14 to the buffer tank 26 via a main filling material line 16.

Preferably, a carbonator 18 can be arranged in the main filling material line 16. The contents can be carbonated at the carbonator 18. The carbonator 18 can, for example, be configured as at least one carbonation nozzle. The carbon dioxide for carbonation can be provided by the carbon dioxide source 20. The carbon dioxide can be supplied from the carbon dioxide source 20 to the carbonator 18 via a gas line 22.

Preferably, a bypass 24 can be arranged around the carbonator 18. By the bypass 24, substantially the same conditions regarding flow and/or pressure for carbonation (CO2 addition) can always be provided.

The filling material can be temporarily stored (buffered) in the buffer tank 26. The buffer tank 26 can receive the filling material via the main filling material line 16. It is possible for the buffer tank 26 to receive additional components, e.g., a syrup, for the filling material via an optional additional filling material line 28.

Preferably, the carbonation of the filling material can be maintained in the buffer tank 26. Preferably, the buffer tank 26 may be pre-charged with carbon dioxide from the carbon dioxide source 20. The buffer tank 26 can, for example, be pre-charged with carbon dioxide at such a pressure that the release of the carbon dioxide bound in the filling material is prevented. For example, the pre-charging of the buffer tank 26 can be achieved by a pre-charging apparatus by which carbon dioxide from the carbon dioxide source 20 can be introduced into a head space of the buffer tank 26.

A circulation line 30 may be included to monitor the quality of the filling material in the buffer tank 26. A circulation pump 32 can be arranged in the circulation line 30. Using the circulation pump 32, filling material can be removed from the buffer tank 26 and returned to it. At least one sensor, e.g., a carbon dioxide sensor and/or a Brix sensor, can be arranged in the circulation line 30.

It is possible that the buffer tank 26 and/or the gas line 22 for receiving sterile air is/are connected to the sterile air source 34.

The filling stations 36 can each be connected to the buffer tank 26. In detail, the buffer tank 26 can be connected to the filling stations 36 via a filling material line 38. The filling material can be supplied from the buffer tank 26 to the filling stations 36 via the filling material line 38.

Optionally, a gas space/head space of the buffer tank 26 can also be connected to the several filling stations 36 via a charging gas line 40. Via the charging gas line 40, charging gas (carbon dioxide) can be supplied from the gas space of the buffer tank 26 to the filling stations 36.

Preferably, the filling stations 36 can be included in a filler carousel or a rotary filler 42 (only schematically indicated in FIG. 1). The filling stations 36 can fill several containers 12 with the filling material simultaneously or at overlapping times. For example, the filling stations 36 can be arranged distributed around a circumference of the filler carousel 42.

Preferably, the filling stations 36 can receive the filling material from the buffer tank 26 (and the filling material line 38) via a rotary distributor 44. Optionally, the filling stations 36 can also receive charging gas from the buffer tank 26 (and the charging gas line 40) via the rotary distributor 44.

The rotary distributor 44 can transfer the filling material and optionally the charging gas from a stationary plant part of the apparatus 10, in which, among other things, the buffer tank 26 and the filling material line 36 and optionally the charging gas line 40 are arranged, to the filler carousel 42 rotating relative thereto.

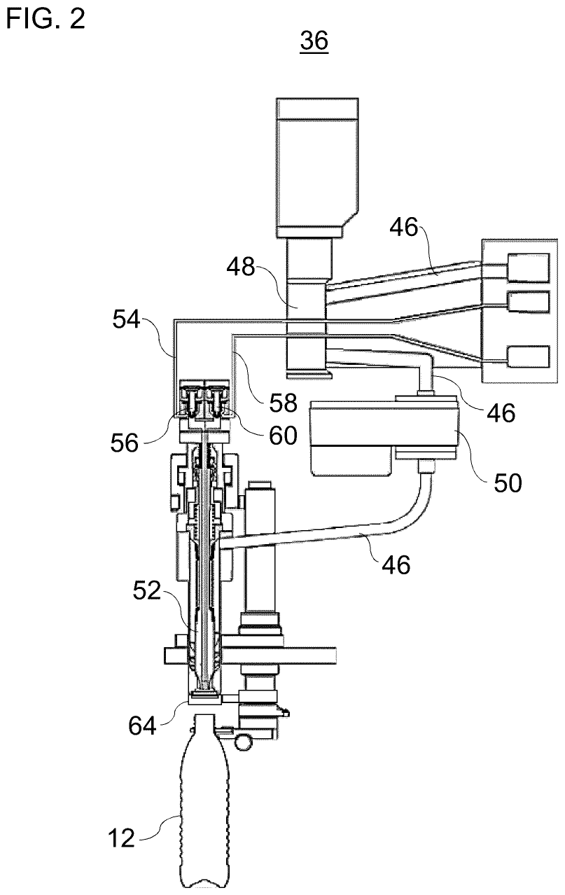

An exemplary filling station 36 is shown in greater detail in FIG. 2.

Each filling station 36 has a filling material path 46, a filling material path valve 48 and a flow meter 50. Each filling station 36 may further comprise, for example, a filling valve 52, a gas path (gas supply path) 54, a gas path valve 56, a relief path 58 and/or a relief valve 60. Preferably, the filling valve 52, the gas path valve 56 and the relief valve 60 together form a filling element of a corresponding filling station 36.

The filling material paths 46 of the filling stations 36 can be connected to the buffer tank 26 (see FIG. 1) for receiving filling material from the buffer tank 26. Preferably, the filling material paths 46 can be connected to the filling material line 38, e.g., via the rotary distributor 44. For example, the filling material paths 46 can be connected to the rotary distributor 44 via a ring channel.

A filling material path valve 48 is arranged in each filling material path 46. The filling material path valve 48 can optionally allow or block a flow through the corresponding filling material path 46 or optionally adjust it. For example, a processing device 74 of the apparatus 10 can selectively operate the filling material path valve 48 to assume a release position or to assume a closed position or optionally to adjust a released flow cross section.

Preferably, the filling material path valve 48 can be a closed-loop control valve or open-loop control valve. Preferably, the filling material path valve 48 can adjust a flow cross section between an open position and a closed position.

A flow meter 50 is arranged in each filling material path 46. The flow meter 50 can, for example, as shown in FIGS. 1 and 2, be arranged in the corresponding filling material path 46 downstream of the filling material path valve 48. Alternatively, the flow meter 50 can be arranged, for example, in the corresponding filling material path 46 upstream of the filling material path valve 48.

The flow meter 50 is configured to measure a flow rate through the corresponding filling material path 46. For example, the flow meter 50 can detect a filling material flow to the filling valve 52. For example, the flow meter 50 can measure the flow rate in terms of quantity and/or volume. The flow meter 50 may output a measurement signal indicating the detected flow rate, for example to a processing device 74 of the apparatus 10.

The flow meter 50 can have any suitable flow rate measurement principle for detecting the flow. Particularly preferably, the flow meter 50 can be a magnetic-inductive flow meter or an ultrasonic flow meter.

The filling valve 52 may be arranged downstream of the filling material path valve 48 and the flow meter 50. Preferably, the filling valve 52 is arranged at a downstream end region of the corresponding filling material path 46. By the filling valve 52, the filling material can be dispensed into a container 12 positioned below the filling valve 52.

For example, the filling valve 52 can be opened to fill the container 12. The filling valve 52 can be closed to block a flow of the filling material through the filling valve 52. It is optionally possible for a flow cross section of the filling valve 52 to be adjustable, e.g., to adjust a flow rate of the filling material through the filling valve 52.

The filling valve 52 is particularly preferably a proportional valve. Due to the configuration as a proportional valve, it is possible to regulate the filling product flow in several stages or, particularly preferably, continuously.

The filling valve 52 can, for example, be configured in the form of a cone valve. The filling valve 52 may, for example, have a valve seat into which a valve cone of the filling valve 52 can be lowered in order to close the filling valve 52. By gradually or continuously lifting the valve cone from the valve seat, the cross section of the annular gap between the valve cone and the valve seat can be varied.

The gas paths 54 of the filling stations 36 can, for example, be connected to a gas space/head space of the buffer tank 26 (see FIG. 1) for receiving charging gas from the buffer tank 26. Preferably, the gas paths 54 can be connected to the charging gas line 40, e.g., via the rotary distributor 44. For example, the gas paths 54 can be connected to the rotary distributor 44 via a ring channel.

A gas path valve 56 can be arranged in each gas path 54. The gas path valve 56 can selectively allow or block a flow through the corresponding gas path 54. For example, a processing device 74 of the apparatus 10 can selectively operate the gas path valve 56 to assume a release position or to assume a closed position.

Preferably, the gas paths 54 can be configured as charging gas paths and the gas path valves 56 can be configured as charging gas path valves. Preferably, charging gas (e.g., from the buffer tank 26) can be supplied to the corresponding container 12 via the gas paths 54 and the (open) gas path valves 56 in order to pre-charge it. The return gas can preferably be returned during filling via the gas paths 54 and the (open) gas path valves 56, e.g., into the buffer tank 26.

However, it is also possible that the gas paths 54 are connected to conduct another gas or to conduct a gas with another function, e.g., to a corresponding gas source or gas sink.

The relief path 58 can allow venting of the container 12 filled with the filling product. For example, the relief path 58 may be connected to the rotary distributor 44 for discharging gas from the head space of the filled container 12.

A relief valve 60 can be arranged in each relief path 58. The relief valve 60 can selectively release or block a flow through the corresponding relief path 58. For example, a processing device 74 of the apparatus 10 can selectively operate the relief valve 60 to assume a release position or to assume a closed position.

During filling operation of the apparatus 10, the filling stations 36 fill the containers 12 with the filling material. The filling stations 36 can receive the filling material from the buffer tank 26. The corresponding filling material paths 46 can be released for filling by opening the corresponding filling material path valves 48, and the filling valves 52 can be opened to fill the containers 12. A desired filling material quantity for a container 12 can be set by the corresponding flow meter 50. Optionally, the containers 12 can be pre-charged with charging gas via the gas paths 54 before filling. The corresponding gas paths 54 can be released for pre-charging by opening the corresponding gas path valves 56.

In addition to the filling operation, the apparatus 10 can also be operated in a cleaning operation. For this purpose, the apparatus 10 can, for example, have a cleaning medium source 62 (shown only schematically in FIG. 1). Optionally, the apparatus 10 may further comprise, for example, a cleaning cap 64 per filling station 36 (shown only schematically in FIG. 2) and a cleaning medium return 66.

The cleaning medium source 62 can supply a cleaning medium to the filling stations 36. The cleaning medium can be used for cleaning, sterilizing and/or rinsing.

For example, the cleaning medium source 62 can supply the cleaning medium to the main filling material line 16. The cleaning medium can be supplied to the buffer tank 26 via the main filling material line 16. The cleaning medium can be supplied to the filling material paths 46 of the filling stations 36 via the filling material line 38. It is also possible for the cleaning medium to be supplied from the main filling material line 16 via a connecting line 68 to the further filling material line 28 for introduction into the buffer tank 26, from where the cleaning medium can in turn be supplied to the filling stations 36.

Preferably, the cleaning medium source 62 can also supply the cleaning medium to the gas paths 54 of the filling stations 36 if these are present and this is desired. For example, the cleaning medium can be supplied from the cleaning medium source 62 via the main filling material line 16 and via a connecting line 68 to the further filling material line 28 for introduction into the charging gas line 40. The cleaning medium can be supplied to the gas paths 54 via the charging gas line 40.

For cleaning operation, the cleaning cap 64 can be movable (e.g., pivotable and/or displaceable) under a filling element or the filling valve 52 of the corresponding filling station 36 in order to return the cleaning medium exiting from the filling valve 52, e.g., to the relief path 58. The cleaning cap 64 can thus allow a so-called CIP internal cleaning and/or SIP internal sterilization of the corresponding filling element/filling station 36. The cleaning cap 64 can be configured, for example, as a (CIP) cleaning-in-place or (SIP) sterilizing-in-place cleaning cap.

The returned cleaning medium can be returned to a cleaning medium return 66 via a relief path 58 released by opening the corresponding relief valve 60. For example, the relief paths 58 can be supplied to the cleaning medium return 66 via the rotary distributor 44.

Preferably, a pump 70 can be arranged in the cleaning medium return 66. The pump 70 can convey the cleaning medium through the filling stations 36 by sucking the cleaning medium to the cleaning medium return 66. Depending on a number of released paths 46 (through open filling material path valves 48) and/or 54 (through open gas path valves 56), the pump 70 can suck in different cleaning agent volumes per time and thus cause different cleaning agent flow rates through the enabled paths 46 and/or 54.

Although the exemplary embodiment with the cleaning caps 64 and the cleaning medium return 66 with the pump 70 is particularly preferred, it should be noted that the techniques disclosed herein are not limited thereto. Alternatively or additionally, in a rinsing operation as part of the cleaning operation, for example, a corresponding filling material outlet of the filling stations 36 can remain free, and the cleaning medium can escape from the filling stations 36 into the environment, e.g., into a collecting tray arranged below the filling valves 52.

It is possible for the apparatus 10 to further comprise a user interface 72 and/or a processing device 74 for operating the apparatus 10.

The user interface 72 may be configured to receive user inputs and/or to output information to a user. For example, the user interface 72 may be a visual, acoustic and/or haptic/tactile user interface. Preferably, the user interface 72 may comprise a, preferably touch-sensitive, display, a loudspeaker, a microphone, a keyboard, a button and/or at least one signal light.

The user interface 72 can be used by a user, for example, to start a setting of the cleaning operation, to start a cleaning operation of the apparatus 10 and/or to start a filling operation of the apparatus 10.

The processing device 74 is configured to operate the apparatus 10, e.g., in a filling operation, in a cleaning operation, and/or to set the cleaning operation.

A special feature of the present disclosure is the method for adjusting the cleaning operation. The setting method is based on the knowledge that at least one valve actuation parameter of the cleaning operation is set on the basis of measurements of the flow meters 50 when passing cleaning medium through the filling stations 36.

The at least one valve actuation parameter may preferably be at least one valve actuation parameter of the filling stations 36. Particularly preferably, the at least one valve actuation parameter can have a target number of simultaneously open filling material path valves 48 and/or a target number of simultaneously open gas path valves 56, as described below by way of example. The at least one valve actuation parameter may alternatively or additionally comprise a corresponding valve control curve of the filling material path valves 48 and/or the gas path valves 56. The at least one valve actuation parameter may alternatively or additionally comprise a corresponding opening duration of the filling material path valves 48 and/or the gas path valves 56. The at least one valve actuation parameter may alternatively or additionally comprise a corresponding opening time and/or a corresponding closing time of the filling material path valves 48 and/or the gas path valves 56.

The method for setting up the cleaning operation can be applied differently depending on the level of expansion and/or degree of automation.

For example, the setting can be carried out before carrying out the actual cleaning operation of the apparatus 10, preferably during initial commissioning of the apparatus 10. For example, the setting may be carried out at the beginning of performing the cleaning operation of the apparatus 10, preferably for the initial setting of the cleaning operation being performed. For example, setting can be carried out, preferably several times, while the cleaning operation of the apparatus 10 is being carried out, preferably for dynamically adjusting the cleaning operation being carried out.

For example, the setting can only be used for cleaning the filling material paths 46 of the filling stations 36. Alternatively, the setting can be used for cleaning the filling material paths 46 and the gas paths 54 of the filling stations 36.

During the setting process, a cleaning medium is first passed through at least some of the filling material paths 46. For this purpose, the filling material path valves 48 arranged in some of the filling material paths 46 are opened. Preferably, only filling material paths 46 are released, but not any existing gas paths 54. The gas path valves 56 can be closed accordingly.

The cleaning medium passed through can, for example, be dispensed from the filling stations 36 into an environment or can be directed to the cleaning medium return 66 by a corresponding cleaning cap 64.

During the passage of the cleaning medium, the filling valves 52 of the corresponding filling stations 36 with the released filling material paths 46 can be opened, or, for example, the filling valves 52 of all filling stations 36 can be opened.

For example, the cleaning medium passed through the released filling material paths 46 can be passed from the cleaning cap 64 of the corresponding filling stations 36 positioned at a filling material outlet of the filling station 36 to the cleaning medium return 66, preferably via the relief path 58, e.g., as in CIP or SIP cleaning. Alternatively, the cleaning medium passed through the released filling material paths 46 can be dispensed from the filling station 36 into an environment of the filling station 36 through the respectively opened filling valve 52, e.g., as in the case of rinsing.

During passage through the released filling material paths 46, the cleaning medium flow rates are measured by the flow meters 50.

Depending on the measured cleaning medium flow rates, a target number of simultaneously open filling material path valves 48 for the cleaning operation can then be set, preferably automatically, preferably by the processing device 74. As already mentioned, the target number of simultaneously open filling material path valves 48 during the cleaning operation is a preferred example of a set valve actuation parameter of the cleaning operation.

Preferably, the target number of simultaneously open filling material path valves 48 can be set as that number of open filling material path valves 48 at which a sum V2_sum of the measured cleaning medium flow rates substantially corresponds to a cleaning medium supply V1_nom, i.e., V1_nom=V2_sum.

The cleaning medium supply V1_nom is a predefined value, preferably a nominal supply (available supply) of the cleaning medium from the cleaning medium source 62. The predefined value can, for example, be received via a communication interface of the apparatus 10 or entered via the user interface 72.

If a sum V2_sum of measured cleaning medium flow rates is less than the predefined cleaning medium supply V1_nom, i.e., V2_sum<V1_nom, then a number of released filling material paths 46 can be increased by opening at least one further one of the filling material path valves 48 until the number of open filling material path valves 48 is reached at which a sum V2_sum of measured cleaning medium flow rates determined for the increased number of released filling material paths 46 substantially corresponds to the predefined cleaning medium supply V1_nom, i.e., V1_nom=V2_sum.

If a sum V2_sum of measured cleaning medium flow rates is greater than the cleaning medium supply V1_nom, i.e., V2_sum>V1_nom, then a number of released filling material paths 46 can be reduced by closing at least one of the open filling material path valves 48 until the number of open filling material path valves 48 is reached at which a sum V2_sum of measured cleaning medium flow rates determined for the reduced number of released filling material paths 46 substantially corresponds to the cleaning medium supply V1_nom, i.e., V1_nom=V2_sum.

It is also possible that an error message will be issued. For example, the processing device 74 can operate the user interface 72 to output a fault message if a sum V2_sum of measured cleaning medium flow rates is outside a predefined tolerance range. The tolerance range can be predefined, for example, based on the predefined cleaning medium supply V1_nom, e.g., by the user interface 72.

For example, the cleaning medium source may be capable of providing a nominal supply of 60 m³/h of cleaning medium. For example, if V1_nom>>V2_sum or V1_nom<<V2_sum, a fault message can be issued.

For example, it can be determined in the above manner that with 150 released filling material paths 46 (or 150 open filling material path valves 48), the sum V2_sum of the 150 measured cleaning medium flow rates of approx. 400 I/h each corresponds to the predefined cleaning agent supply of, for example, approx. 60 m³/h (60,000 l/h). Thus, the target number of simultaneously open filling material path valves 48 for the cleaning operation can be predefined as 150. When carrying out this cleaning operation, only 150 of, for example, a total of 160 filling material paths 46 would be released or only 150 of, for example, a total of 160 filling material path valves 48 would be open. The filling material path valves 48 can be opened and closed, preferably in a rolling manner, so that an actual number of simultaneously open filling material path valves 48 corresponds to the predefined target number of simultaneously open filling material path valves 48.

The setting method can optionally be modified or supplemented by considering the gas paths 54, if, for example, the gas paths 54 are present and their consideration is desired. When considering the gas paths 54, the at least one valve actuation parameter of the cleaning operation to be set can preferably have a target number of simultaneously open gas path valves 56 during the cleaning operation.

For this purpose, the cleaning medium can be passed through at least some, preferably all, of the gas paths 54. The gas paths 54 to be released can be released by opening the gas path valves 56 arranged in the gas paths 54 to be released. The passage preferably takes place simultaneously or at least temporally overlapping with a passage of the cleaning medium through some of the filling material paths 46.

The cleaning medium passed through can, for example, be dispensed from the filling stations 36 into an environment or can be directed to the cleaning medium return 66 by a corresponding cleaning cap 64.

During the passage of the cleaning medium, the filling valves 52 of the corresponding filling stations 36 with the released gas paths 54 and the released filling material paths 46 can be opened, or, for example, the filling valves 52 of all filling stations 36 can be open.

Again, the cleaning medium flow rates through the released filling material paths 46 can be measured by the corresponding flow meters 50. The sum of the measured cleaning medium flow rates is again V2_sum.

The cleaning medium flow rate through the released gas paths 54 can then be determined, for example, by the processing device 74 as follows.

The cleaning medium supply from the cleaning medium source 62 and/or a cleaning medium discharge from the filling stations 36 can be measured (=V1_meas), e.g., by a flow meter (not shown in the figures) downstream of the cleaning medium source 62 and/or a flow meter (not shown in the figures) in the cleaning medium return line 66.

The cleaning medium flow rate V3_det through the released gas paths 54 can be determined depending on the sum of the measured cleaning medium flows V2_sum through the released filling material paths 46 and the measured cleaning medium supply or cleaning medium discharge V1_meas. Preferably, the cleaning medium flow rate V3_det through the released gas paths 54 can be calculated directly as the difference between the measured cleaning medium supply or cleaning medium discharge V1_meas and the sum of the measured cleaning medium flow rates V2_sum, i.e., V3_det=V1_meas-V2_sum.

The target number of simultaneously open gas path valves 56 during the cleaning operation can then preferably be set depending on the determined cleaning medium flow rate V3_det through the released gas paths 54.

Preferably, a number of released gas paths 54 and/or a number of released filling material paths 46 can be varied until a cleaning medium flow rate V3_det is determined which ensures that a predefined minimum flow rate and/or a predefined minimum flow rate through the released gas paths 54 is reached. For example, the corresponding pipe diameter of the gas paths 54 must be flowed through with a minimum flow rate of 1.5 m/s. The number of released gas paths 54 underlying this determined cleaning medium flow rate V3_det can then be set as the target number of simultaneously open gas path valves 56 during the cleaning operation. The number of released filling material paths 46 underlying this determined cleaning medium flow rate V3_det can then be set as the target number of simultaneously open filling material path valves 48 during the cleaning operation.

For example, a cleaning medium supply V1_meas of 60m²/h (60,000 l/h) is measured. The apparatus has, for example, 160 filling stations, i.e., also 160 filling material path valves 48 and 160 gas path valves 56. The desired cleaning medium flow rate V3_det can be obtained, for example, if the target number of simultaneously open filling material path valves 48 is approximately 75 (at 400 l/h per filling material path 46) and the target number of simultaneously open gas path valves 56 is approximately 150 (at 200 l/h per gas path 54). It is understood that other combinations of target numbers are also possible, in particular those in which the target number of simultaneously open gas path valves 56 corresponds to a total number of gas path valves 56, i.e., 160 in the example.

In general terms, the target number of simultaneously open gas path valves 56 during the cleaning operation and the target number of simultaneously open filling material path valves 48 during the cleaning operation are adjusted in a coordinated manner. The cleaning operation can then preferably be carried out in such a way that the filling material path valves 48 and/or gas path valves 56 are opened and closed in accordance with the set at least one valve actuation parameter, preferably in a rolling manner, preferably to keep a total cleaning medium flow rate through the several filling stations constant.

Preferably, the filling material path valves 48 are operated during the cleaning operation to gradually change a flow rate of the cleaning medium passed through when opening and closing the corresponding filling material path valve 48, so that pressure surges when opening and closing the corresponding filling material path valve 48 can be prevented. This can be achieved, for example, by a pressure shock-damping closing characteristic, which, for example, excludes an abrupt closing of the corresponding filling material path valve 48.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the sub-claims are also disclosed independently of all the features of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 apparatus
12 container
14 filling material source
16 main filling material line
18 carbonator
20 carbon dioxide source
22 gas line
24 bypass
26 buffer tank
28 additional filling line
30 circulation line
32 circulation pump
34 sterile air source
36 filling station
38 filling material line
40 charging gas line
42 filler carousel
44 rotary distributor
46 filling material path
48 filling material path valve
50 flow meter
52 filling valve
54 (e.g., charging) gas path
56 (e.g., charging) gas path valve
58 relief path
60 relief valve
62 cleaning medium source
64 cleaning cap
66 cleaning medium return
68 connecting line
70 pump
72 user interface
74 processing device

What is claimed is:

1. A method for setting a cleaning operation of an apparatus, for filling containers with a filling material, wherein the apparatus has several filling stations, each having a filling material path, a filling material path valve arranged in the corresponding filling material path, and a flow meter arranged to measure a flow rate through the corresponding filling material path, the method comprising:
passing a cleaning medium through at least some of the filling material paths by releasing at least some of the filling material paths by opening the corresponding filling material path valves;
measuring cleaning medium flow rates through the released filling material paths by the corresponding flow meters; and
setting at least one valve actuation parameter of the cleaning operation of the apparatus depending on the measured cleaning medium flow rates.

2. The method according to claim 1, wherein:
the at least one valve actuation parameter comprises a target number of simultaneously opened filling material path valves during the cleaning operation.

3. The method according to claim 1, wherein:
the setting of the at least one valve actuation parameter is further dependent on a predefined cleaning medium supply from a cleaning medium source of the apparatus.

4. The method according to claim 3, wherein at least one of the following conditions is met:
the target number of simultaneously open filling material path valves during the cleaning operation is set as the number of open filling material path valves at which a sum of the measured cleaning medium flow rates substantially corresponds to the predefined cleaning medium supply;
the target number of simultaneously open filling material path valves during the cleaning operation is set such that, if a sum of the measured cleaning medium flow rates is less than the predefined cleaning medium supply, a number of released filling material paths is increased by opening at least one further one of the filling material path valves until the number of open filling material path valves is reached at which a sum of the measured cleaning medium flow rates determined for the increased number of released filling material paths substantially corresponds to the predefined cleaning medium supply; and
the target number of simultaneously open filling material path valves during the cleaning operation is set such that, if a sum of the measured cleaning medium flow rates is greater than the predefined cleaning medium supply, a number of released filling material paths is reduced by closing at least one of the open filling material path valves until the number of open filling material path valves is reached at which a sum of the measured cleaning medium flow rates determined for the reduced number of released filling material paths substantially corresponds to the predefined cleaning medium supply.

5. The method according to claim 3, further comprising:
outputting a fault message by a user interface of the apparatus if a sum of the measured cleaning medium flow rates is outside a predefined tolerance range.

6. The method according to claim 3, wherein at least one of:
the predefined cleaning medium supply is a nominal supply of the cleaning medium from the cleaning medium source; and
outputting a fault message by a user interface of the apparatus if a sum of the measured cleaning medium flow rates is outside a predefined tolerance range based on the predefined cleaning medium supply.

7. The method according to claim 1, wherein:
the several filling stations further each have a gas path and a gas path valve arranged in the corresponding gas path; and
the at least one valve actuation parameter comprises a target number of simultaneously opened gas path valves during the cleaning operation.

8. The method according to claim 7, wherein the method further comprises:
passing the cleaning medium through at least some of the gas paths by releasing the at least some of the gas paths by opening the corresponding gas path valves.

9. The method according to claim 8, further comprising:
measuring a cleaning medium supply from at least one of a cleaning medium source of the apparatus and a cleaning medium discharge from the several filling stations.

10. The method according to claim 9, further comprising:
determining a cleaning medium flow rate through the released gas paths depending on the measured cleaning medium flow rates through the released filling material paths and on the at least one of the measured cleaning medium supply and the measured cleaning medium discharge.

11. The method according to claim 10, wherein at least one of:
the gas path is a charging gas path, and the gas path valve is a charging gas path valve;
the target number of simultaneously open gas path valves is set as the number of open gas path valves at which at least one of a predefined minimum flow and a predefined minimum flow rate through the released gas paths is achieved;
the target number of simultaneously open gas path valves during the cleaning operation and a target number of simultaneously open filling material path valves during the cleaning operation are adjusted in a coordinated manner;
the passing the cleaning medium through at least some of the gas paths passes the cleaning medium through all of the gas paths by opening the corresponding gas path valves;
the passing the cleaning medium through at least some of the gas paths by releasing at least some of the gas paths by opening the corresponding gas path valves in a simultaneously or temporally overlapping manner with the passing of the cleaning medium through at least some of the filling material paths;
in the step of measuring a cleaning medium supply, the setting of the at least one valve actuation parameter is further dependent on the at least one of the measured cleaning medium supply and the measured cleaning medium discharge; and
in the step of determining a cleaning medium flow rate through the released gas paths, the setting of the at least one valve actuation parameter is further dependent on the determined cleaning medium flow rate through the released gas paths.

12. The method according to claim 1, wherein at least one of the following conditions is met:
at least one of the filling material path valves are closed-loop or open-loop control valves and are configured to adjust a flow cross section between an open position and a closed position; and
the filling material path valves are operated in such a way that they each at least one of close with a pressure-shock-damping closing characteristic and do not close abruptly.

13. The method according to claim 1, wherein:
the cleaning medium passed through is dispensed by the filling station into an environment of the filling station; or
the cleaning medium passed through is guided from a cleaning cap of the corresponding filling station positioned at a filling material outlet of the corresponding filling station to a cleaning medium return.

14. The method according to claim 13, wherein the cleaning medium passed through is guided from the cleaning cap of the corresponding filling station positioned at the filling material outlet of the corresponding filling station to the cleaning medium return via a relief path of the corresponding filling station.

15. The method according to claim 1, wherein:
the several filling stations each have a filling valve arranged in the corresponding filling material path downstream of the corresponding filling material path valve for dispensing the filling material into a container; and
during the passage of the cleaning medium, the filling valve of the corresponding filling station is open or the filling valves of all filling stations are open.

16. A method for cleaning an apparatus for filling containers with a filling material, wherein the apparatus has several filling stations, each having a filling material path, a filling material path valve arranged in the corresponding filling material path, and a flow meter arranged to measure a flow rate through the corresponding filling material path, the method comprising:
setting a cleaning operation of the apparatus by a method according to one of the preceding claims; and
performing the cleaning operation for cleaning the apparatus, wherein at least one of the following conditions is met:
the setting is carried out before carrying out the cleaning operation;
the setting is carried out at the beginning of the cleaning operation; and
the setting is carried out during the cleaning operation.

17. The method according to claim 16, wherein the cleaning operation is carried out such that at least one of:
at least one of the filling material path valves and gas path valves of the apparatus are opened and closed in accordance with the at least one valve actuation parameter set; and
the filling material path valves are operated in such a way that they each at least one of close with a pressure-shock-damping closing characteristic and do not close abruptly.

18. The method according to claim 16, wherein at least one of:
the apparatus is a rotary apparatus;
the setting is carried out during initial commissioning of the apparatus;
the setting is carried out at the beginning of the cleaning operation for the initial setting of the cleaning operation being carried out;
the setting is carried out several times during the cleaning operation;
the setting is carried out for dynamically adjusting the cleaning operation carried out;
the at least one of the filling material path valves and gas path valves of the apparatus are opened and closed in a rolling manner; and
the at least one of the filling material path valves and gas path valves of the apparatus are opened and closed to keep a constant total cleaning medium flow rate through the several filling stations.

19. An apparatus for filling containers with a filling material, wherein the apparatus is configured to perform the method according to claim 1.

20. The apparatus according to claim 19, wherein the apparatus is a rotary apparatus.
